(19) United States
(12) Patent Application Publication
(10) Pub. No.: US 2008/0000569 A1
(43) Pub. Date: Jan. 3, 2008

(54) LAMINATION METHOD AND APPARATUS

(76) Inventor: Jeanne Williamson, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/755,235

(22) Filed: May 30, 2007

Related U.S. Application Data
(60) Provisional application No. 60/812,335, filed on Jun. 8, 2006.

(51) Int. Cl. B32B 37/18

(52) U.S. Cl. 156/64; 156/378

(57) ABSTRACT

An apparatus and method for making composite structures and articles therefrom are disclosed herein. Embodiments of the present invention provide a laminating apparatus comprising a first alignment bar for aligning a first lateral edge of a first substrate, a second alignment bar coupled to the base for aligning a second lateral edge of the first substrate, and a third alignment bar for aligning a lateral edge of a second substrate. In embodiments, the first and second substrates may be offset relative to each other to conform to a die-cutting process. Other embodiments may be described and claimed.

### CROSS REFERENCE TO RELATED APPLICATIONS

The present application is a non-provisional application of, and claims priority to, provisional application 60/812,335, entitled “METHOD AND APPARATUS FOR MAKING SHORT-RUN PRINTED ITEMS,” filed Jun. 8, 2006. The specification of said provisional application is hereby incorporated in its entirety, except for those sections, if any, that are inconsistent with this specification.

### TECHNICAL FIELD

Embodiments of the present invention relate to apparatuses and methods for making composite structures and articles therefrom, and more particularly, to making composite structures and articles for short-run production.

### BACKGROUND

Cost-effectively producing high-quality printed items from thick materials for short or limited runs has posed a challenge for vendors of specialty and/or customized printed articles.

Traditionally, press equipment, printing equipment, and/or printing presses have been used to create printed sheets, which are sometimes die-cut to create smaller printed articles therefrom. Press equipment, printing equipment, and printing presses require a user to create a film and a metal plate for a sheet to be printed with an image. If a printed sheet will be replicated hundreds or thousands of times, creating a film and/or metal plate may have little cost-impact on the user. To create a film and/or metal plate for a printed sheet on a much smaller, custom scale, however, may be cost-ineffective, at least in terms of material and time.

Although solutions exist for creating short-run printed sheets, the solutions may not be appropriate for use with thick substrates. For example, digital presses have been used to create short-run, custom images on paper and other thin material. Digital presses, however, may be limited in the types of materials they can accept. For example, digital presses generally can only print onto substrates up to a certain thickness and may not be capable of accepting thicker materials, thus limiting their applicability.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is an isometric view of an exemplary laminating apparatus, in accordance with various embodiments of the present invention.

FIG. 2 illustrates the exemplary laminating apparatus of FIG. 1 and an exemplary laminating method, in accordance with various embodiments of the present invention.

FIG. 3 illustrates the exemplary laminating apparatus of FIG. 1 and an exemplary laminating method, in accordance with various embodiments of the present invention.

FIG. 4 illustrates the exemplary laminating apparatus of FIG. 1 and an exemplary laminating method, in accordance with various embodiments of the present invention.

FIG. 5 illustrates the exemplary laminating method, in accordance with various embodiments of the present invention.

FIG. 6a illustrates an exemplary composite structure, in accordance with various embodiments of the present invention.

FIG. 6b illustrates exemplary composite articles, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The description may use the phrases “in an embodiment,” “in embodiments,” or “in various embodiments,” which may each refer to one or more of the same or different embodiments. Furthermore, the terms “comprising,” “including,” “having,” and the like, as used with respect to embodiments of the present invention, are synonymous.

The phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB),” that is, A is an optional element.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

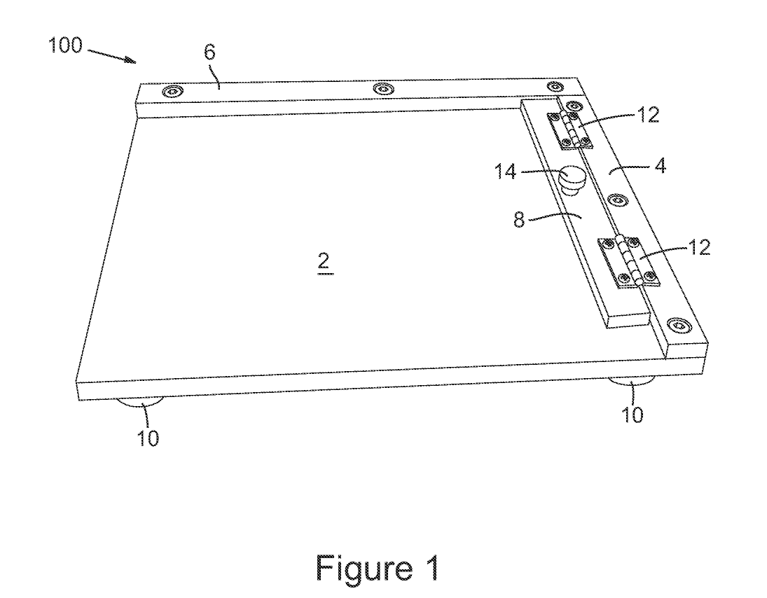

Turning now to FIG. 1, illustrated is a laminating apparatus 100 for making a composite structure comprising two or more substrates laminated together. The composite structure may be used as a blank from which one or more articles may be die-cut therefrom, the one or more resulting die-cut articles comprising a portion of each of the substrates used for forming the composite structure. According to various embodiments, one or more of the substrates may include one or more images thereon such as, for example, graphics, lettering, textural effects, etc. Such images may be configured such that an article die-cut from the composite structure may include a corresponding image in a desired position on the die-cut article.

According to various embodiments, laminating apparatus 100 may be used for substantially consistent and/or accurate positioning of substrates for laminating together, particularly for applications wherein the substrates are not or cannot be aligned relative to each other. For example, in some embodiments, it may be desirable or necessary for a first substrate to be offset from a second substrate. Such offsetting may be desired or necessary due to any number of reasons including, for example, the orientation of images on a substrate or the capabilities or settings of a die-cutting apparatus.

According to various embodiments, substrates may be offset relative to each other due to a difference in sizes of the substrates. For example, a first substrate may be a first size, while a second substrate may be a second size, different from the first size. If multiple composite structures comprising the different sized sheets are to be used for die-cutting one or more articles, it may be desirable that the substrates used for each composite structure be generally positioned similarly to the others.

In some embodiments, it may be desirable to position the smaller sheet to align with one of the lateral edges of the larger sheet yet be offset relative to one of the other lateral edges (for example, one of the perpendicular lateral edges). Although such offsetting may serve any number of purposes, according to some embodiments, it may be necessary or desirable due to a particular die-cutting process and/or apparatus, or a similar process and/or apparatus for separating an article from a composite structure. For example, a die-cutting apparatus may be used for forming articles from a single composite structure or from multiple stacked composite structures simultaneously. For embodiments wherein composite structures include images thereon, the images corresponding to articles to be die-cut from the composite structures, substantially consistent and/or accurate positioning of the substrates may ensure that each of the die-cut articles will include thereon one or more of the images in substantially the desired position. For example, it may be desirable that an image be centered or otherwise disposed on the article formed from the composite structure. Misalignment of first and second substrates, and thus misalignment of images on the surface of the composite structure, may result in the one or more images being off-center relative to the corresponding printed articles.

A substrate may comprise any material suitable for the application. A substrate may comprise a material such as, for example, paper, a paper-based material, a metal material, or a fiberboard material, polyethylene, polyethylene terephthalate, polypropylene, vinyl, polyvinyl chloride, any one of various synthetic materials suitable for the purpose, or some combination thereof. A substrate may be generally flexible or generally rigid, or may be generally transparent or generally opaque, depending on the desired composition of the resulting composite structure or the article(s) formed therefrom. For example, a composite structure for making an article that is disposable or for short-term use but is still rigid may include thick paper such as paperboard. In other embodiments, a longer-lasting product may include a substrate comprising metal or plastic. Any other material may be suitable for forming a composite structure, depending on the application.

According to various embodiments, a substrate may comprise a material suitable for printing or for processing in a printing apparatus. For example, a printing apparatus used for forming images onto a substrate may be configured to process substrates having a thickness within a certain range. In addition to or instead of thickness limitations, a printing apparatus or printing process may be configured to process only substrates made from certain types of materials, having a certain rigidity, or having a certain quality (e.g., texture, surface smoothness, etc.).

Any combination of substrates may be used in forming a composite structure, and a combination of substrates may be selected to achieve a desired composition of the resulting composite structure. According to various embodiments, a selected substrate may provide a desired level of rigidity and/or durability. For example, one or more of the substrates may include a material suitable for use with a printing apparatus or printing process such that one or more images may be formed thereon and then laminated to another substrate suitable for the particular application. For example, a thick paperboard substrate may have laminated thereto a thinner substrate having an image formed thereon. In some embodiments, the thick paperboard may not be suitable for processing through a printing apparatus or printing process due to its thickness, but the thinner substrate may be so suited and so a rigid article including the desired image formed thereon may be possible.

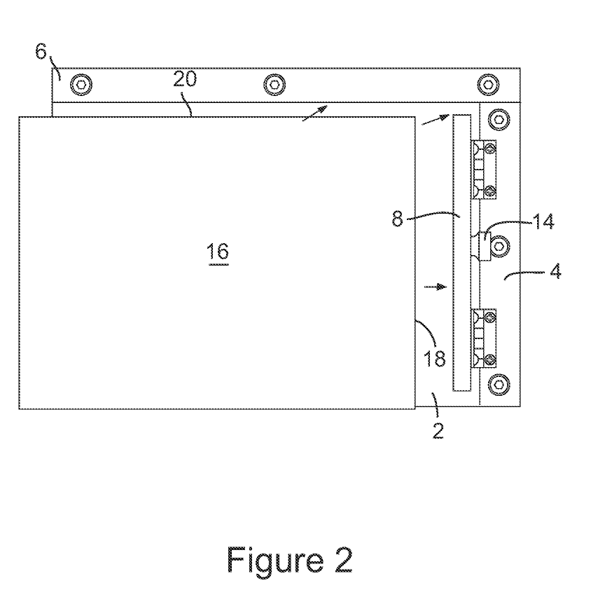

Referring again to FIG. 1 and also to FIG. 2, laminating apparatus 100 may include a base 2, a first alignment bar 4 coupled to base 2, a second alignment bar 6 coupled to base 2, and a third alignment bar 8 operatively coupled to base 2. As illustrated in FIG. 2, first alignment bar 4 may be configured to align a first lateral edge 18 of a first substrate 16, and second alignment bar 6 may be configured to align a second lateral edge 20 of first substrate 16.

According to the illustrated embodiment, first alignment bar 4 and second alignment bar 6 are disposed orthogonally to each other, and so configured, may be suitable for aligning two perpendicular lateral edges of first substrate 16. According to other embodiments, however, first 4 and second 6 alignment bars may be differently configured. For example, first alignment bar 4 may be disposed at an angle greater than or less than 90° relative to second alignment bar 6, depending on the application.

For some embodiments, one or both of first 4 and second 6 alignment bars may be moveable relative to base and/or relative to the other of first 4 and second 6 alignment bar. Moveability of one or both of first 4 and second 6 alignment bars may allow for adaptability of laminating apparatus 100 to different shapes of substrates. For example, a substrate may not necessarily comprise lateral edges that are oriented at perfect 90° angles. A laminating apparatus including a moveable alignment bar may allow for accommodation of such varying substrates.

In various embodiments, laminating apparatus 100 may include skid-resistant feet 10 for resisting movement of laminating apparatus 100 upon an application of force. In various other embodiments, laminating apparatus 100 may comprise a clamp or other features to mechanically couple laminating apparatus to a working surface. A working surface may include any surface such as, for example, a table or some other flat surface, and according to various embodiments, a working surface may form base 2 of laminating apparatus 100.

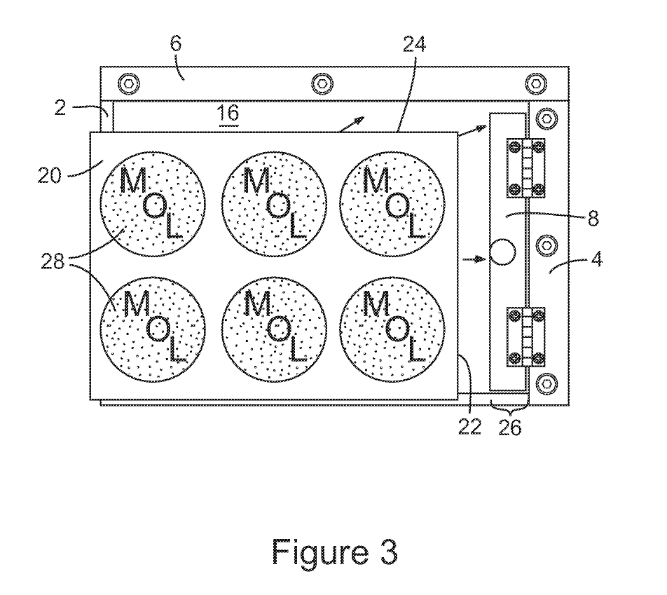

Third alignment bar 8 may be configured to align one or more lateral edges of a second substrate 20, as illustrated in FIG. 3. According to various embodiments, third alignment bar 8 may be configured to move between an open position to allow first substrate 16 to be placed onto base 2 (as illustrated in FIG. 2), and a closed position to allow first substrate 2 to be disposed between third alignment bar 8 and base 2 (as illustrated in FIG. 3), the closed position configured to align one or more lateral edges of second substrate 20. According to various embodiments, third alignment bar 8 may be configured to apply a force to first substrate 16 to inhibit movement of first substrate 16 relative to base 2.

As illustrated, for moving between open and closed positions, third alignment bar 8 may include one or more hinges 12, which may allow third alignment bar 8 to pivot about an axis parallel to base 2. In some embodiments, third alignment bar 8 may be configured to move to one of open and closed positions automatically through use of, for example, a spring or other biasing element. According to various other embodiments, however, third alignment bar 8 may be configured to move laterally relative to base 2 or may be configured to pivot about an axis perpendicular to base 2. For facilitating movement of third alignment bar 8, laminating apparatus 100 may further comprise a handle 14 for manually controlling movement of third alignment bar 8. Those skilled in the art will recognize that other configurations are possible within the scope of the present disclosure.

As illustrated in FIG. 3, second substrate 20 may be placed onto first substrate 16. A first lateral edge 22 of second substrate 20 may be aligned to third alignment bar 8, and a second lateral edge 24 of second substrate 20 may be aligned to second alignment bar 6.

Second substrate 20 may include one or more images 28 thereon corresponding to one or more articles to be die-cut from a composite structure formed from first 16 and second 20 substrates. Image 28 may be formed using a press such as, for example, a digital press. In various other embodiments, image 28 may formed, for example, using a photocopying apparatus, a laser printer, a traditional off-set press, etc., or some combination thereof. According to various embodiments, first substrate 16 may include one or more images thereon, in addition to or alternatively to including images 28 on second substrate 20, depending on the application.

Aligning second substrate 20 to third alignment bar 8 may provide an offset corresponding to a width 26 of third alignment bar 8. Accordingly, width 26 of third alignment bar 8 may be configured with a width 26 corresponding to a desired offset of second substrate 20 relative to first substrate 16. To accommodate varying sizes of substrates, third alignment bar 8 may be configured to be adjustable and/or removable to allow third alignment bar 8 to be modified to conform to a new substrate size, new printing apparatus/process, or new die-cutting apparatus/process, or some combination thereof. For some embodiments, rather than modifying third alignment bar 8, third alignment bar 8 may be replaced by another third alignment bar having the desired configuration.

For the illustrated embodiments, third alignment bar 8 is configured to align only first lateral edge 22 of second substrate 20. For various other embodiments, however, third alignment bar 8 may be configured to align more than one lateral edge of second substrate 20. For example, third alignment bar 8 may be configured to align first lateral edge 22 and second lateral edge 24 of second substrate 20. For some of the embodiments, third alignment bar 8 may be L-shaped or similarly shaped to align both lateral edges 22, 24 of second substrate 20.

Having aligned first 16 and second 20 substrate, the substrates 16, 20 may be laminated or otherwise coupled together to form a composite structure. One or both of first and second substrate may include an adhesive for coupling first 16 and second 20 substrate together. An adhesive may be any adhesive known in the art. For example, an adhesive may comprise a self-adhesive material, a non-self-adhesive material, a pressure-sensitive adhesive, structural adhesive, a pre-applied adhesive, or non-pre-applied adhesive, or some combination thereof. For most embodiments, any adhesive suitable for the purpose may be enlisted and still be within the scope of the present disclosure.

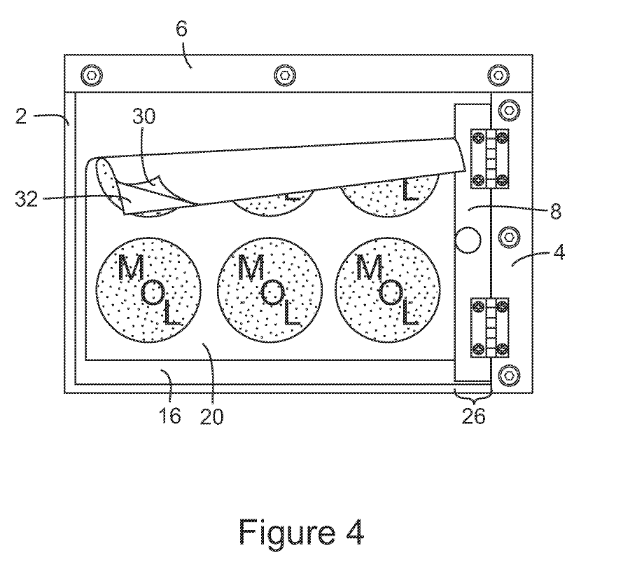

According to some embodiments, first 16 and/or second 20 substrate may include a self-adhesive material with a peel-off backing to be removed when adhesion is desired. As illustrated in FIG. 4, for example, second substrate 20 includes an adhesive 32 with a peel-off backing 30. According to various embodiments, peel-off backing 30 may be of the type that comprises two or more strips of backing material so that only a portion of the backing 30 need be removed at a time.

Referring still to FIG. 4, while second substrate 20 is still disposed on first substrate 16 and aligned to second 6 and third 8 alignment bars, a portion of adhesive 32 disposed on second substrate 20 is exposed by peeling off a portion of backing 30 and the exposed adhesive 32 is applied to first substrate 16 to couple substrates 16, 20 together. As noted previously, however, rather than a pre-applied self-adhesive material, adhesive 32 may comprise some other adhesive known in the art.

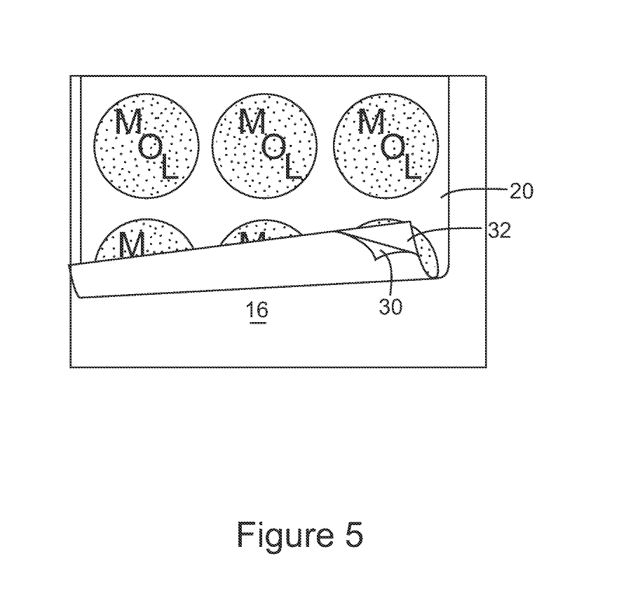

First 16 and second 20 substrate, now partially adhered to each other, may be sufficiently coupled that first 16 and second 20 substrate may be removed from laminating apparatus 100. As illustrated in FIG. 5, once first 16 and second 20 substrates are removed are removed from laminating apparatus 100, the remaining backing 30 may be removed to completely adhere first 16 and second 20 substrate together. In various other embodiments, first 16 and second 20 substrate may alternatively be completely adhered to each other while still on laminating apparatus 100.

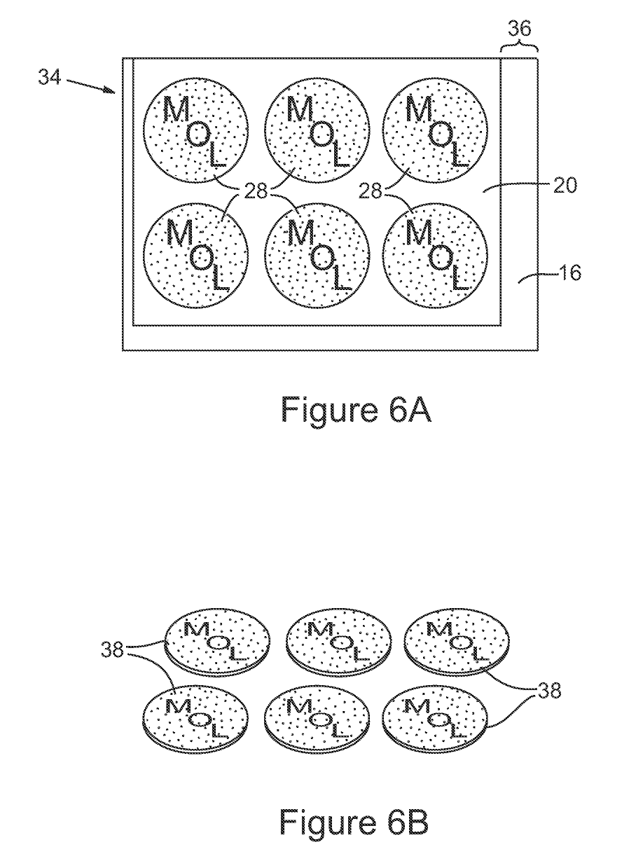

FIG. 6a illustrates an embodiment of a composite structure 34 comprising first substrate 16 and second substrate 20. As illustrated, second substrate 20 is disposed on first substrate 16 with an offset 36 corresponding to width 26 of third alignment bar 8 (as illustrated in FIGS. 3 and 4). Composite structure 34 may undergo a die-cutting process, or similar process, for separating articles 38 corresponding to images 28 from composite structure 34, as illustrated in FIG. 6b. The resulting articles 38 comprise a portion of first substrate 16 and a portion of second substrate 20, with the desired image 28 formed thereon.

As illustrated, the resulting article 38 may comprise a beverage coaster including a desired image 28. As will be recognized by those skilled in the art, other articles may be die-cut from a composite structure. For example, various high-quality custom articles such as novelty items, placards, tags, etc., may be formed from a composite structure. According to various embodiments, customized articles using thick materials or other material unsuitable or undesirable for traditional press and/or printing methods for short or limited runs may be possible. For example, the illustrated article 38 may comprise a customized image 28 formed on second substrate 20 using a readily-available apparatus such as, for example, a printer or digital press. Rather than being limited to an end-product article formed solely from a material capable of being printed using such a readily-available apparatus, second substrate 20 may be adhered to a thick first substrate 16 to form a composite structure 34, which may readily be die-cut to form the desired article 38. According to various embodiments of the present invention, offsetting first 16 and second 20 substrate relative to each other a pre-determined amount allows for multiple composite structures to be consistently and accurately die-cut using the same die-cutting apparatus without the need to adjust or re-adjust the die-cutting apparatus for each composite structure.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. An apparatus for laminating a first substrate with a second substrate, comprising:
a base;
a first alignment bar coupled to the base for aligning a first lateral edge of the first substrate;
a second alignment bar coupled to the base, orthogonally to the first alignment bar, for aligning a second lateral edge of the first substrate; and
a third alignment bar operatively coupled to the base for aligning a first lateral edge of the second substrate.

2. The apparatus of claim 1, wherein the third alignment bar is configured to move between an open position to allow the first substrate to be placed onto the base, and a closed position to allow the first substrate to be disposed between the third alignment bar and the base.

3. The apparatus of claim 2, wherein the third alignment bar is pivotally coupled to at least one of the first alignment bar and the second alignment bar.

4. The apparatus of claim 2, wherein the third alignment bar is configured to align the first lateral edge of the second substrate when the third alignment bar is in the closed position.

5. The apparatus of claim 2, wherein the third alignment bar is further configured to align a second lateral edge of the second substrate.

6. The apparatus of claim 5, wherein the third alignment bar is configured to align the second lateral edge of the second substrate when the third alignment bar is in the closed position.

7. The apparatus of claim 1, wherein the third alignment bar is configured to allow the first substrate to be disposed between the third alignment bar and the base, and further configured to apply a force to the first substrate to inhibit movement of the first substrate relative to the base.

8. The apparatus of claim 1, wherein the third alignment bar is further configured to offset the first lateral edge of the second substrate relative to the first lateral edge of the first substrate, the offset being substantially equal to the width of the third alignment bar.

9. A method for laminating a first substrate with a second substrate, comprising:
aligning a first lateral edge of the first substrate to a first alignment bar and a second lateral edge of the first substrate to a second alignment bar;
placing a third alignment bar onto the first substrate;
aligning a first lateral edge of the second substrate to the third alignment bar; and
adhering the first substrate with the second substrate to form a composite structure.

10. The method of claim 9, further comprising aligning a second lateral edge of the second substrate to the second alignment bar

11. The method of claim 9, further comprising die-cutting at least one article from the composite structure.

12. The method of claim 11, wherein the at least one article comprises a beverage coaster.

13. The method of claim 9, wherein the first substrate is adhered with the second substrate using an adhesive material.

14. The method of claim 9, wherein the adhering comprises:
adhering no more than a first portion of the first substrate with no more than a first portion of the second substrate to leave un-adhered a remaining second portion of the first substrate and a remaining second portion of the second substrate;
after adhering the first portions of the first substrate and the second substrate, removing the first substrate and the second substrate from the first, second, and third alignment bars; and
after removing the first substrate and the second substrate, adhering the remaining second portion of the first substrate with the remaining second portion of the second substrate.
